(19) United States
(12) Patent Application Publication
(10) Pub. No.: US 2002/0118866 A1
(43) Pub. Date: Aug. 29, 2002

(54) Method of and system for the automatic registration of anatomically corresponding positions for perfusion measurements

(76) Inventors: Marcel Breeuwer, Eindhoven (NL); Marcel Johannes Quist, Eindhoven (NL)

Correspondence Address: U.S. Philips Corporation, 580 White Plains Road, Tarrytown, NY, 10591, US

(21) Appl. No.: 10/059,431

(22) Filed: Jan. 29, 2002

(30) Foreign Application Priority Data
Feb. 2, 2001 (EP) 01200373.7

(51) Int. Cl. G06K 9/00

(52) U.S. Cl. 382/128; 382/229

(57) ABSTRACT

An automatic quantitative analysis method is developed so as to analyze perfusion cardiovascular images. First the image registration per data set is performed so as to compensate for translation and rotation of the target region of interest over the acquisition time. Next a parameter, for example, a maximum intensity projection, is calculated in order to average out misalignments of the target region of interest within each data set. Finally, parameter registration is performed to calculate the co-ordinate translation matrix between the anatomically corresponding pixels within the target region of interest. The co-ordinate translation matrix can also be used to calculate local perfusion values.

The invention relates to a method of automatically registering anatomically corresponding positions in at least a first image data set and a second image data set that comprise a first and a second series of images.

The invention also relates to a system for carrying out such a method.

A method of registering anatomically corresponding positions in two image data sets is known from WO 97/17894. The cited document describes a method of realizing automatic registration of scintigraphic images of perfusion measurements in the myocardium. The essence of such perfusion measurements is to create images that are acquired in substantially the same phase of a cardiac cycle of a patient to be examined and that show a cross-section of the myocardiurn in the state of rest and in the state of stress. Analysis of such images enables conclusions to be drawn concerning, for example the degree of perfusion of the myocardium of the patient. The cited document discloses a method of automatically registering the perfusion measurements in rest and in stress.

Considering the fact that the myocardium is practically always in motion, detection inaccuracies occur in the determination of the corresponding positions in an image in rest and in a corresponding image in stress. In order to eliminate the motion artefacts, the image data sets are acquired, generally speaking, in one and the same phase of the cardiac cycle of the patient during which the myocardium is quasi-stationary. This phase is unambiguously related to an R peak in the electrocardiogram. However, it has been found that, even when the R triggering is applied during the acquisition of the image data sets, the images to be analyzed of a cross-section of the myocardium exhibit shifts, rotations and/or deformations relative to one another, so that the accuracy of the determination of the corresponding positions in the images in rest and in stress is degraded.

It is an object of the invention to provide a method of automatically registering anatomically corresponding positions in two graphic data sets, which method essentially eliminates shifts, rotations and deformations in the graphic images to be analyzed. To this end, the method in accordance with the invention includes the steps of:

performing a registration operation on the first image data set in order to obtain a first registered image data set;

performing a registration operation on the second image data set in order to obtain a second registered image data set;

calculating a first parameter for the registered first image data set;

calculating a second parameter for the registered second image data set;

performing a registration operation on the first parameter relative to the second parameter.

The first and the second image data sets comprise, for example images of a cross-section of the myocardium in rest and in stress as a function of time. In this case a first image data set comprises images of the same cross-section of the myocardium at different instants. Due to inaccuracies in the R peak triggering, respiration of the patient and possible irregularities in the cardiac cycle, such cross-sections may be shifted, rotated or deformed relative to one another. The same holds for the images in the second image data set. The first two steps of the method in accordance with the invention eliminate the artefacts that are caused by the shifts, rotations or deformations in the images, that is, by carrying out a registration operation. This registration operation can be carried out by means of algorithms of a rigid or a non-rigid transformation that are known per se. In the first case translations and rotations are eliminated and in the second case the deformations are also eliminated. The registration operation yields a registered image data set where the relevant anatomical pixels of the successive images within each registered series are situated at corresponding image coordinates (i,j) in the imaging plane. Such relevant pixels are, for example, the boundaries of the myocardium. Each individual image in the first and in the second registered image data set contains a region of relevant pixels, for example, a region that is situated at the center of the image and is enclosed by the non-relevant pixels. It has been found that each series of registered images is advantageously reduced to one image in order to enhance the accuracy of the analysis. In the method in accordance with the invention this reduction is achieved by means of the steps of calculating a first parameter for the registered first image data set, of calculating a second parameter for the registered second image data set, and of subsequently performing a registration operation on the first parameter relative to the second parameter.

A version of the method in accordance with the invention in which the first and the second image data set comprise perfusion measurements of the myocardium in rest and in stress, respectively, carried in substantially the same phase of a cardiac cycle of an object, is characterized in that the first and the second parameter are Maximum Intensity Projections (MIP) calculated for the first and for the second registered image data set, respectively. The calculation of an Maximum Intensity Projection is known per se. This operation yields one image per registered data set that originally comprises N images, each pixel (i,j) in such an MIP image assuming a maximum intensity value of the pixels (i,j) in the series N of the registered data set. In other words, the maximum intensity values of the pixels, originally distributed over 3 dimensions, are backprojected to one plane while maintaining their positions (i,j) in the plane. Because the relevant anatomical information in the registered image data sets is situated at substantially the same image co-ordinates (i,j), the MIP calculation results in further averaging out of geometrical shifts. This ensures reliable registration of the first image data set relative to the second image data set for the subsequent operations.

A further version of the method in accordance with the invention, in which the first and the second image data set comprise perfusion measurements of the myocardium in rest and in stress, respectively, carried out in substantially the same phase of a cardiac cycle of an object, is characterized in that the first and for the second parameter are contour parameters calculated for the first and the second registered image data set, respectively. An example of a contour parameter consists of a set of pixel co-ordinates that describes the course of a boundary of the myocardium. The boundary of the myocardium can be determined by means of contour detection algorithms that are known per se. This operation offers the advantage that exclusively the relevant pixels are retained for the subsequent operations.

A further version of the method in accordance with the invention is characterized in that results of the registration operation of the second parameter are used to determine a third parameter. The registration operation of, for example, the MIPs yields, for example, a table in which the positional relation between the pixels is defined for the anatomically corresponding regions in the images of the myocardium in rest and in stress. This can be realized by calculating a co-ordinate transformation matrix between the anatomically corresponding pixels (i,j) in rest and in stress (i′,j′). This operation can be performed by means of rigid or non-rigid transformation algorithms that are known per se. In comparison with a rigid transformation, a non-rigid transformation offers the advantage that the deformations can be eliminated.

A further version of the method in accordance with the invention is characterized in that the second parameter is a MIP while the third parameter is a degree of relative local perfusion of a cardiac muscle. For perfusion measurements each pixel within a relevant region of the myocardium represents a degree of the perfusion. The registration operation performed on the MIPs yields a table in which a positional relation is defined between the pixels of the anatomically corresponding regions of the images in rest (i,j) and in stress (i′,j′), respectively, for example, by calculating a co-ordinate transformation matrix. This table enables comparison of the degree of local perfusion of the myocardium in rest and in stress.

A system in accordance with the invention includes an MR apparatus and an ECG apparatus that co-operates with the MR apparatus so as to produce a first and a second image data set, first registration means for performing a registration operation on the first and the second image data set so as to obtain a first and a second registered image data set, calculation means for calculating a first and a second parameter, and second registration means for performing a registration operation on the first parameter relative to the second parameter.

These and other aspects of the invention will be described in detail hereinafter with reference to some Figures; therein:

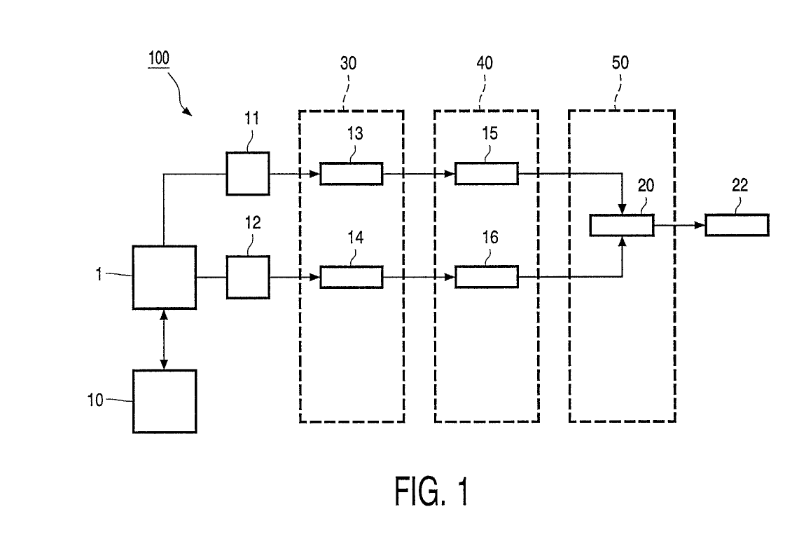

FIG. 1 shows diagrammatically the system for carrying out the method in accordance with the invention;

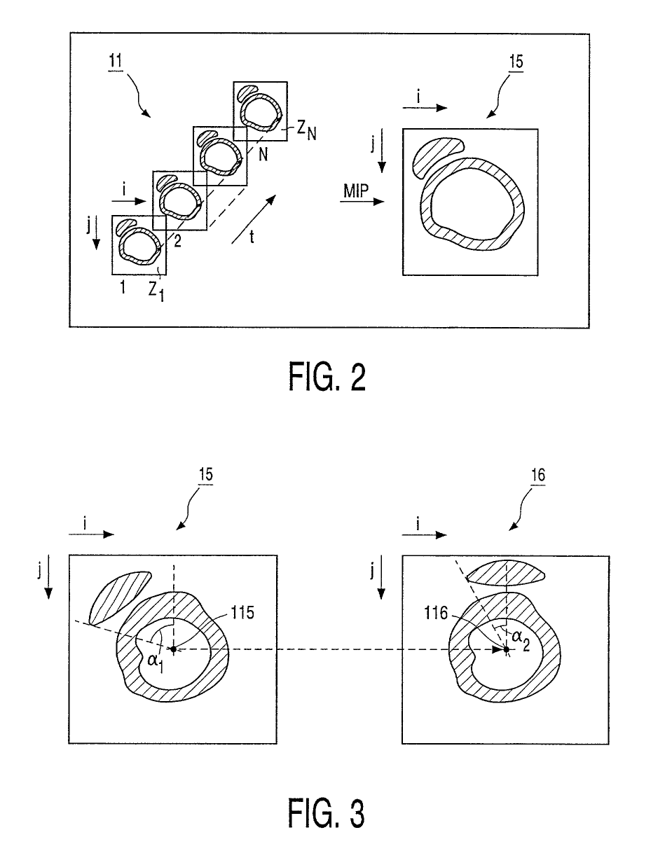

FIG. 2 illustrates diagrammatically the calculation of a first parameter;

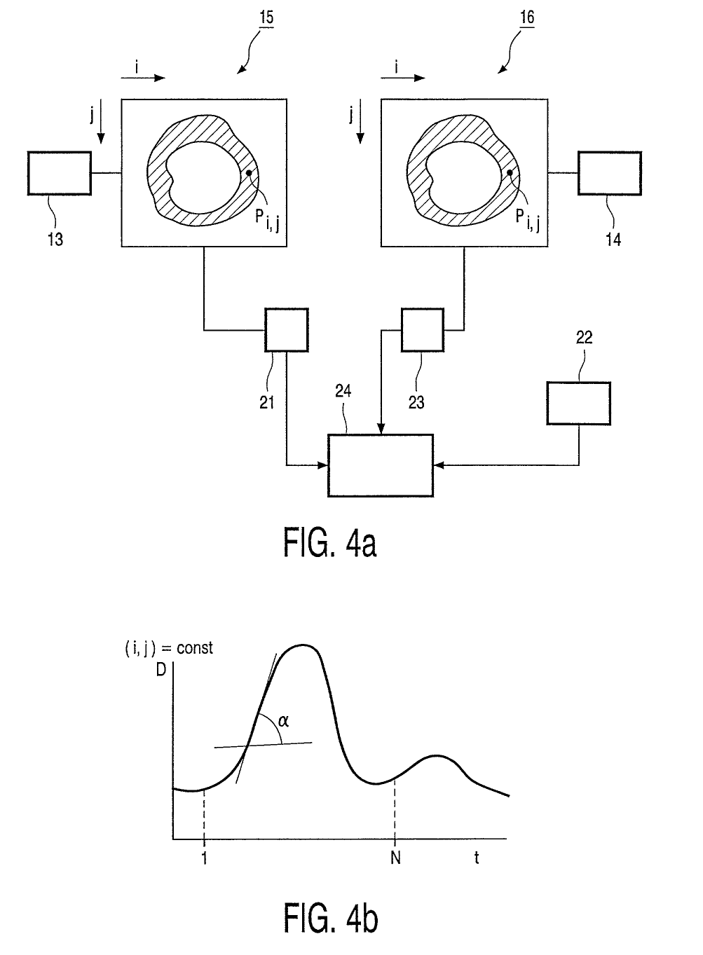

FIG. 3 illustrates diagrammatically a registration operation on the first parameter relative to the second parameter;

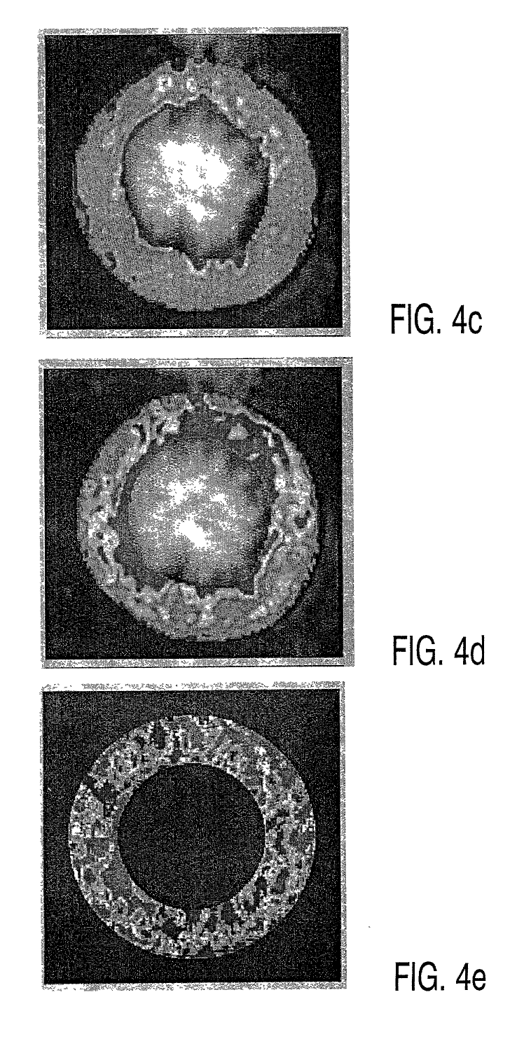

FIG. 4a illustrates diagrammatically the determination of a third parameter;

FIG. 4b shows diagrammatically a perfusion curve of the myocardium;

FIG. 4c shows an example of the mapping of a perfusion parameter on an anatomy of the myocardium in rest;

FIG. 4d shows an example of the mapping of a perfusion parameter on an anatomy of the myocardium in stress, and

FIG. 4e shows an example of the mapping of a third parameter on the anatomy of the myocardium.

FIG. 1 is a diagrammatic representation of a system for carrying out the method in accordance with the invention. The system 100 includes an MR apparatus 1 and a co-operating ECG apparatus 10 for generating image data sets 11, 12, said image data sets representing two-dimensional images of the myocardium in rest 11 and in stress 12. In order to reduce the motion artefacts of the myocardium, the acquisition of the image data sets is correlated to a phase in the cardiogram, that is, so-called ECG triggering. The co-operation of an MR apparatus and an ECG apparatus for the acquisition of the MR images that are synchronized with a cardiac cycle is known per se from “An ECG Trigger Module for the Acquisition of Cardiac MR Images”, Computers in Cardiology, 1994, p. 533. Generally speaking, the acquisitions take place in the diastolic end phase of the cardiac cycle in which the myocardium is quasi-stationary. During the perfusion measurements, MR images are formed of one and the same cross-section of the myocardium, that is, as a function of time, each pixel of the myocardium representing a degree of local perfusion. For the diagnostic analysis it is important to compare the regions of the myocardium and a degree of perfusion in rest and in stress. The representations of the myocardium in the successive images might be shifted relative to one another due to irregularities in the cardiac cycle or for other reasons. This introduces errors in the registration of the images acquired in rest relative to the images acquired in stress. To this end, the system 100 also includes first registration means 30 for performing a registration operation so as to obtain a registered image data set. The registration operation results in an image data set that comprises the same number N of two-dimensional images as an original image data set, the anatomically corresponding pixels of the successive images within each two-dimensional plane being situated at the same coordinates (i,j) in the imaging plane. A cross-section of the myocardium constitutes an example of such relevant pixels. The registration operations are performed by means of the means 30 that may comprise a computer program for applying an algorithm of a rigid or a non-rigid transformation that is known per se. The computer program is stored in a dedicated computer that is not shown in FIG. 1. The system 100 also includes arithmetic means 40 for calculating a first parameter 15 and a second parameter 16. An example of such a parameter is formed by a Maximum Intensity Projection (MIP) that is calculated for each registered image data set 13, 14. The arithmetic means 40 may comprise a computer program for executing the MIP calculation. This calculation will be described in detail hereinafter with reference to FIG. 2. The system also includes second registration means 50 for performing a registration operation 20 on the first parameter 15 relative to the second parameter 16. The registration operation on the first parameter relative to the second parameter will be described in detail hereinafter with reference to FIG. 3. This registration operation 20 yields, for example, a table 22 in which a positional relation between the relevant pixels for an MIP image in rest relative to the relevant pixels for an MIP image in stress is defined.

FIG. 2 diagrammatically illustrates an MIP operation. Assume that the registered image data set 11 comprises N images of one and the same cross-section of the myocardium that have been acquired as a function of time t, the index i indicating columns of pixels and the index j indicating rows of pixels in a plane. Because this graphic data set comprises the mutually registered images, the relevant pixels are situated at the same coordinates (i,j) within each imaging plane. The intensity of a pixel (i,j) within the relevant region is dependent on the quantity of contrast medium present in a volume element or voxel (i,j,N) at the instant t. This means that for one and the same pixel (i,j) the maximum value of the intensity lies somewhere in the series 1 . . . N. The MIP operation searches the maximum pixel intensity that is distributed between pixel values z₁ . . . Z_{N} for a pixel (i,j) and projects this value onto one imaging plane while maintaining the pixel co-ordinates (i,j). This operation has a favorable effect on the contrast of the relevant region in relation to an irrelevant vicinity. The MIP calculation 15 also results in the further averaging out of the small shifts within the relevant region.

FIG. 3 illustrates diagrammatically the registration operation of an MIP in rest 15 relative to an MIP in stress 16. As has already been explained, the MIP forming pixels offer information for the perfusion measurements as a function of time concerning the perfusion of the myocardium in rest and in stress. Furthermore, because of the nature of these measurements there is no a priori known relation between the spatial position of the relevant region on the individual MIP. The registration operation determines an operation that is required for an image 15 so as to achieve anatomical correspondence with an image 16. To this end, for example, a translation transformation 115, 116 and a rotation transformation α1 and α2 are calculated for the pixels (i,j). It may also be necessary to apply a non-rigid transformation, that is, if the MIPs are distorted relative to one another. This calculation yields a table in which a necessary transformation is defined for every anatomically corresponding pixel pair (i,j) and (i′,j′), respectively, within the MIP in rest and the MIP in stress, respectively.

FIG. 4a illustrates diagrammatically the determination of a third parameter 24, for example, for a perfusion curve as shown in FIG. 4b. As has already been explained for the perfusion measurements, each pixel within the relevant region represents a degree of perfusion of the myocardium. FIG. 4b shows a perfusion curve D as a function of time t for one pixel (i,j). An important diagnostic parameter is formed by a maximum value of the upslope a of this curve. A table 22 is used so as to correlate the values for the upslope a that are calculated per anatomically relevant pixel (i,j) and (i′,j′), respectively, for the images in rest 21 and in stress 23. This table contains a positional relation between the relevant anatomically corresponding pixels between the images acquired in rest and in stress. The table 22 also enables calculation of a ratio of the degree of perfusion in stress and in rest α_{I/R} for all diagnostically relevant corresponding pixels (i,j) and (i′,j′), respectively.

The FIGS. 4c and 4d show an example of color mapping of the degree of perfusion a of the myocardium in rest and in stress, that is, superposed on the anatomy of the myocardium. A further relevant diagnostic parameter consists of a ratio of the degree of perfusion in stress and in rest α_{I/R}. FIG. 4e shows color mapping of this ratio on a myocardium in a diagrammatic representation.

1. A method of automatically registering anatomically corresponding positions in at least a first image data set (11) and a second image data set (12) that comprise a first and a second series of images, which method includes the steps of:
performing a registration operation on the first image data set in order to obtain a first registered image data set (13);
performing a registration operation on the second image data set in order to obtain a second registered image data set (14);
calculating a first parameter (15) for the registered first image data set (13);
calculating a second parameter (16) for the registered second image data set (14);
performing a registration operation (20) on the first parameter (15) relative to the second parameter (16).

2. A method as claimed in claim 1, in which the first image data set (11) and the second image data set (12) comprise perfusion measurements of the myocardium in rest and in stress, respectively, carried out in substantially the same phase of a cardiac cycle of an object, the first and the second parameter being Maximum Intensity Projections (MIP) (15) calculated for the first registered image data set and for the second registered image data set, respectively.

3. A method as claimed in claim 1, in which the first image data set (11) and the second image data set (12) comprise perfusion measurements of the myocardium in rest and in stress, respectively, carried out in substantially the same phase of a cardiac cycle of an object, the first and the second parameter being contour parameters calculated for the first registered image data set and for the second registered image data set, respectively.

4. A method as claimed in one of the preceding claims, in which results of the registration operation (20) on the first parameter (15) relative to the second parameter (16) are used to determine a third parameter (24).

5. A method as claimed in claim 4, in which the first parameter (15) and the second parameter (16) are MIPs and in which the third parameter (24) is a degree of relative local perfusion of a cardiac muscle (α_{I/R}).

6. A method as claimed in one of the preceding claims, in which at least one of the registration operations (20) is performed by way of a rigid transformation.

7. A method as claimed in one of the preceding claims, in which at least one of the registration operations (20) is performed by way of a non-rigid transformation.

8. A system (100) for carrying out the method claimed in claim 1, which system includes an MR apparatus (1) and an ECG apparatus (10) that co-operates with the MR apparatus in order to produce a first image data set (11) and a second image data set (12), first registration means (30) for performing a registration operation on the first image data set (13) and the second image data set (14) in order to obtain a first and a second registered image data set, arithmetic means (40) for calculating a first parameter (15) and a second parameter (16), and second registration means (50) for performing a registration operation on the first parameter (15) relative to the second parameter (16).
